(19) United States
(12) Patent Application Publication
(10) Pub. No.: US 2014/0048328 A1
(43) Pub. Date: Feb. 20, 2014

(54) WAVEGUIDE TUBE AND METHOD OF USE THEREOF

(71) Applicant: XIAO-LIAN HE, Shenzhen (CN)

(72) Inventor: XIAO-LIAN HE, Shenzhen (CN)

(21) Appl. No.: 13/682,760

(22) Filed: Nov. 21, 2012

(30) Foreign Application Priority Data
Aug. 14, 2012 (CN) 201210287851X

(51) Int. Cl. H02G 3/22

(52) U.S. Cl. CPC H02G 3/22
USPC 174/667; 29/592.1

(57) ABSTRACT

A waveguide tube includes a penetration tube and a shielding pipe. The penetration tube extends from an anechoic chamber. The shielding pipe is connected to a distal end of the penetration tube. The penetration tube and the shielding pipe are made of metal and metallic powders are poured into the pipe to sealing and surround an internal electrical cable. An input pipe for the powders extends upward from a top of the shielding pipe. A top end of the input pipe is sealed with a removable upper sealing cap.

### BACKGROUND

1. Technical Field

The present disclosure relates to a waveguide tube and a method of using the waveguide tube.

2. Description of Related Art

In electromagnetic compatibility (EMC) test, a waveguide tube is used in an anechoic chamber. Wires in the anechoic chamber extend through the waveguide tube, such that devices outside the anechoic chamber can attempt to communicate with devices inside the anechoic chamber. Most waveguide tubes cannot completely prevent noise from entering into the anechoic chamber, therefore improvement is required.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an exemplary embodiment of a waveguide tube.

FIG. 2 is a flowchart of an exemplary embodiment of a method of use of the waveguide tube of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

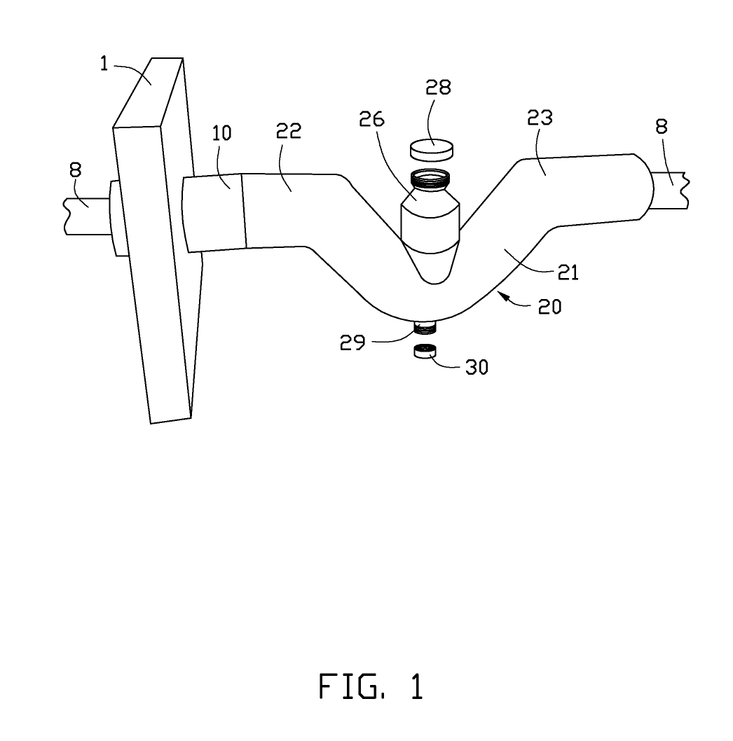

Referring to FIG. 1, an exemplary embodiment of a waveguide tube includes a penetration tube 10 and a shielding pipe 20. The penetration tube 10 and the shielding pipe 20 are made of metal for preventing electrical noise or electromagnetic interference from entering into an anechoic chamber 1.

The penetration tube 10 extends from the anechoic chamber 1. Wires 8, such as signal wires, from inside of the anechoic chamber 1 extend through the penetration tube 10, such that devices in the anechoic chamber 1 can communicate with devices outside the anechoic chamber 1.

The shielding pipe 20 includes a substantially V-shaped main pipe 21 and two connection pipes 22 and 23. The connection pipes 22 and 23 extend from ends of the main pipe 21 away from each other. A distal end of the connection pipe 22 is connected to a distal end of the penetration tube 10 opposite to the anechoic chamber 1. The wires 8 extend through the penetration tube 10, the connection pipe 22, the main pipe 21, and the connection pipe 23 in that order, and are connected to the devices (not shown) outside the anechoic chamber 1.

An input pipe 26 extends upward from a recessed portion at the inner point where the two arms of the V-shaped main pipe 21 meets. The input pipe 26 communicates with the shielding pipe 20. An upper sealing cap 28 seals a distal end of the input pipe 26. An output pipe 29 extends downward from a protruding portion of the V-shaped main pipe 21. The output pipe 29 communicates with the shielding pipe 20. A lower sealing cap 30 seals a distal end of the output pipe 29. In the embodiment, an internal diameter of the input pipe 26 is greater than an internal diameter of the output pipe 29.

In use, the output pipe 29 is sealed with the lower sealing cap 30. Metal magnetic powders are fed into the shielding pipe 20 through the input pipe 26 until the input pipe 26 is filled with metal magnetic powders to the distal end of the input pipe 26.

The metal magnetic powders fill up all the spaces between the shielding pipe 20 and the wires 8 in the shielding pipe 20. The input pipe 26 is sealed with the upper sealed cap 28. In order to ensure that the space between the wires 8 and the shielding pipe 20 is entirely filled up with the metal magnetic powders, the distal end of the input pipe 26 is the same height as or taller than the connection pipes 22 and 23.

Noise from outside the anechoic chamber 1 cannot enter the anechoic chamber 1 through the shielding pipe 20 because the metal magnetic powders completely isolate the anechoic chamber 1 from the external environment.

When the lower sealing cap 30 is removed from the output pipe 29, the metal magnetic powders in the shielding pipe 20 can be drained out of the shielding pipe 20.

In other embodiments, the main pipe 21 of the shielding pipe 20 may be other shapes, such as U-shaped, arc-shaped, or wave-shaped. In addition, the two connection pipes 22 and 23 can be omitted. One end of the main pipe 21 is directly connected to the penetration tube 10. Moreover, the output pipe 29 and the lower sealing cap 30 can be omitted if the shielding pipe 20 can be inverted, gravity will allow the metal magnetic powder in the shielding pipe 20 to pour out of the shielding pipe 20 through the input pipe 26. One of the distal ends of the shielding pipe 20 can extend directly from the anechoic chamber 1, and the wires 8 extend through the shielding pipe 20, thus the penetration tube 10 can be omitted.

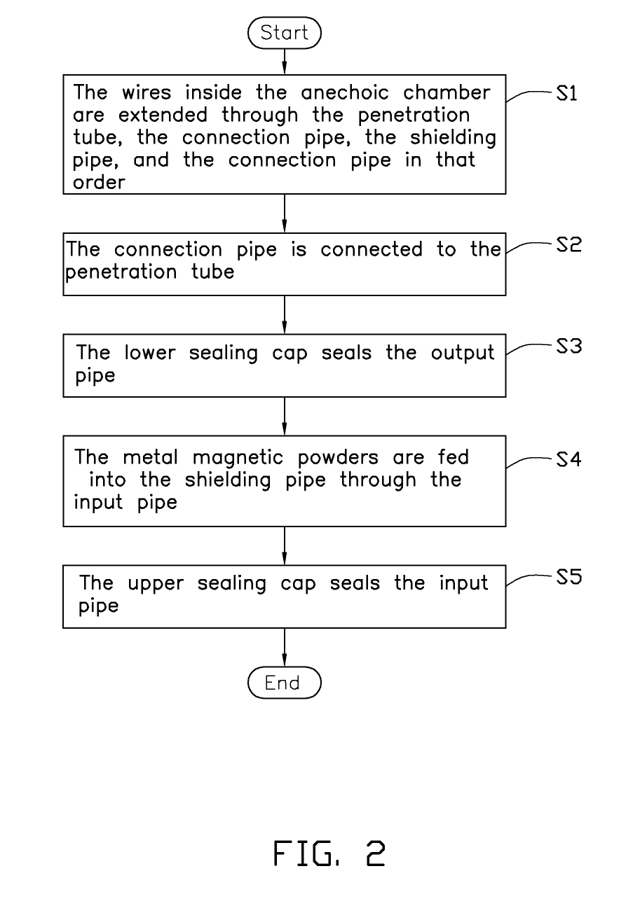

FIG. 2 shows a method for using the above-mentioned waveguide tube, the method includes the following steps.

In step S1, the wires 8 from inside of the anechoic chamber 1 extend through the penetration tube 10 and through the shielding pipe 20 in that order.

In step S2, the connection pipe 22 is connected to the penetration tube 10.

In step S3, the lower sealing cap 30 seals the output pipe 29.

In step S4, metal magnetic powders are fed into the shielding pipe 20 through the input pipe 26 until the level of the metal magnetic powders reaches the distal end of the input pipe 26.

In step S5, the upper sealing cap 28 seals the input pipe 26.

The foregoing description of the embodiments of the disclosure has been presented only for the purposes of illustration and description and is not intended to be exhaustive or to limit the disclosure to the precise forms disclosed. Many modifications and variations are possible in light of the above disclosure. The embodiments were chosen and described in order to explain the principles of the disclosure and their practical application so as to enable others of ordinary skill in the art to utilize the disclosure and various embodiments with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A waveguide tube, comprising:
a penetration tube extending from an anechoic chamber, wherein the penetration tube is made of metal; and
a shielding pipe connected to a distal end of the penetration tube opposite to the anechoic chamber, wherein the shielding pipe is made of metal, an input pipe extends upward from a top of the shielding pipe, a top end of the input pipe is sealed with a removable upper sealing cap;
wherein metal magnetic powder is poured into the shielding pipe through the input pipe until the metal magnetic powder is full to a distal end of the input pipe.

2. The waveguide tube of claim 1, wherein an output pipe extends downward from a bottom of the shielding pipe, a bottom end of the output pipe is sealed with a removable lower sealing cap.

3. The waveguide tube of claim 1, wherein two connection pipes extend from two distal ends of the shielding pipe away from each other, one of the connection pipes is connected to the penetration tube.

4. The waveguide tube of claim 3, wherein the top end of the input pipe is the same height with or taller than the connection pipes.

5. The waveguide of claim 1, wherein the shielding pipe is substantially V-shaped.

6. A method, comprising:
providing a waveguide tube comprising a shielding pipe connected to an anechoic chamber, wherein the shielding pipe is made of metal, an input pipe extends upward from a top of the shielding pipe, a top end of the input pipe is sealed with a removable upper sealing cap;
extending wires from inside of the anechoic chamber through the shielding pipe;
feeding metal magnetic powders into the shielding pipe through the input pipe until the shielding pipe is filled with the metal magnetic powders; and
sealing the input pipe with the upper sealing cap.

7. The method of claim 6, wherein the waveguide tube further comprises an output pipe extended downward from a bottom of the shielding pipe, a bottom end of the output pipe is sealed with a removable lower sealing cap, the metal magnetic powders are operable to flow out of the shielding pipe through the output pipe in response to the lower sealing cap being removed from the output pipe.

8. A waveguide tube, comprising:
a shielding pipe extending from an anechoic chamber, wherein the shielding pipe is made of metal; and
an input pipe extending upward from a top of the shielding pipe, wherein a top end of the input pipe is sealed with a removable upper sealing cap;
wherein metal magnetic powder is poured into the shielding pipe through the input pipe until the metal magnetic powder is full to a distal end of the input pipe.
